(19) United States
(12) Patent Application Publication
(10) Pub. No.: US 2019/0227724 A1
(43) Pub. Date: Jul. 25, 2019

(54) METHOD AND DEVICE FOR PROTECTING A WORKING MEMORY

(71) Applicant: Robert Bosch GmbH, Stuttgart (DE)

(72) Inventors: Achim Schaefer, Grossbottwar (DE); Andrew Borg, Port of Spain, Woodbrook (TT); Gary Morgan, Thixendale (GB); Gunnar Piel, Hemmingen (DE); Paul Austin, Dunnington York (GB)

(21) Appl. No.: 16/338,806

(22) PCT Filed: Sep. 20, 2017
(86) PCT No.: PCT/EP2017/073743

§ 371 Date: Apr. 2, 2019

(30) Foreign Application Priority Data
Oct. 4, 2016 (DE) 10 2016 219 202.7

(51) Int. Cl. G06F 3/06

(52) U.S. Cl. CPC G06F 3/0622; G06F 9/45558; G06F 3/0673; G06F 3/0659

(57) ABSTRACT

A method for protecting a working memory, including the following features:—memory areas of the working memory are optionally assigned to a first class or a second class; prior to a program execution, at least the memory areas of the first class are entered into a configuration table of the memory protection unit; and when access to a destination area among the memory areas of the second class is requested during the program execution, the destination area is entered into the configuration table before the access is granted.

### FIELD

The present invention relates to a method for protecting a working memory. The present invention moreover relates to a corresponding device, to a corresponding computer program, and to a corresponding storage medium.

### BACKGROUND INFORMATION

In memory management, memory protection refers to the ability of operating systems and so-called hypervisors to divide the available working memory and to separate running programs or guest systems from one another in such a way that a crash of an individual program—triggered by a programming error, for example—does not impair the stability of other programs or of the overall system. The programs monitored in this way are thus prevented from inadvertently or intentionally accessing the memory area of other programs or from using the operating system other than through standardized interfaces.

Memory protection units (MPUs) or more complex memory management units (MMUs) which support memory protection are sufficiently known. Within the scope of the following statements, the designation “memory protection unit” shall thus be understood in a broad sense of the word, which expressly includes advanced memory management units having the ability to translate virtual addresses.

Memory protection units were originally designed as an external additional component for microprocessors, but according to the related art are directly integrated into high performance processors or at least situated in their vicinity. However, embedded systems and in particular microcontrollers which traditionally were only designed to execute a single application are also increasingly equipped with virtualization and memory protection mechanisms.

German Patent Application No. DE 10 2014 208 848 A1 describes a method and a computer program for carrying out memory accesses. A hypervisor is used for this purpose in conjunction with a memory protection unit, via which the memory accesses are carried out.

### SUMMARY

The present invention provides a method for protecting a working memory, a corresponding device, a corresponding computer program—for example in the form of a hypervisor or an operating system—and a machine-readable storage medium.

The approach according to the present invention is based on the finding that the number of configurable memory areas and access rights in this regard in a generic hardware memory protection unit is limited. As a result of this limitation, the number of memory areas used by a virtual machine (VM) may exceed the capabilities of the hardware—such as in the case of a hypervisor. In this regard, at the most a merging of individual memory areas is possible, which limits the granularity of the memory protection configuration, so that it is no longer possible to completely preclude unauthorized accesses by virtual machines to certain memory locations. This problem may be exacerbated in that a hypervisor reserves several entries of the corresponding configuration table for internal use or provides a virtual MPU implementation for virtual machines which, in turn, require a memory protection unit themselves, for example to implement a protected operating system within the virtual machine.

An advantage of one specific embodiment of the present invention may be that it overcomes the numerical limitation of the configurable memory areas of a generic memory protection unit to be able to accurately establish all memory areas used directly and indirectly—for example via the hypervisor—by a virtual machine. Such an approach allows the virtual machine to access an almost arbitrary number of memory areas, without being limited by the capabilities of the hardware memory protection unit.

The measures described herein may allow advantageous refinements of and improvements on the basic aspects of the present invention.

### BRIEF DESCRIPTION OF THE DRAWINGS

Exemplary embodiments of the present invention are shown in the figures and are described in greater detail below.

FIG. 1 shows the activity diagram of a method according to a first specific embodiment.

FIG. 2 schematically shows a control unit according to a second specific embodiment.

### DETAILED DESCRIPTION OF EXAMPLE EMBODIMENTS

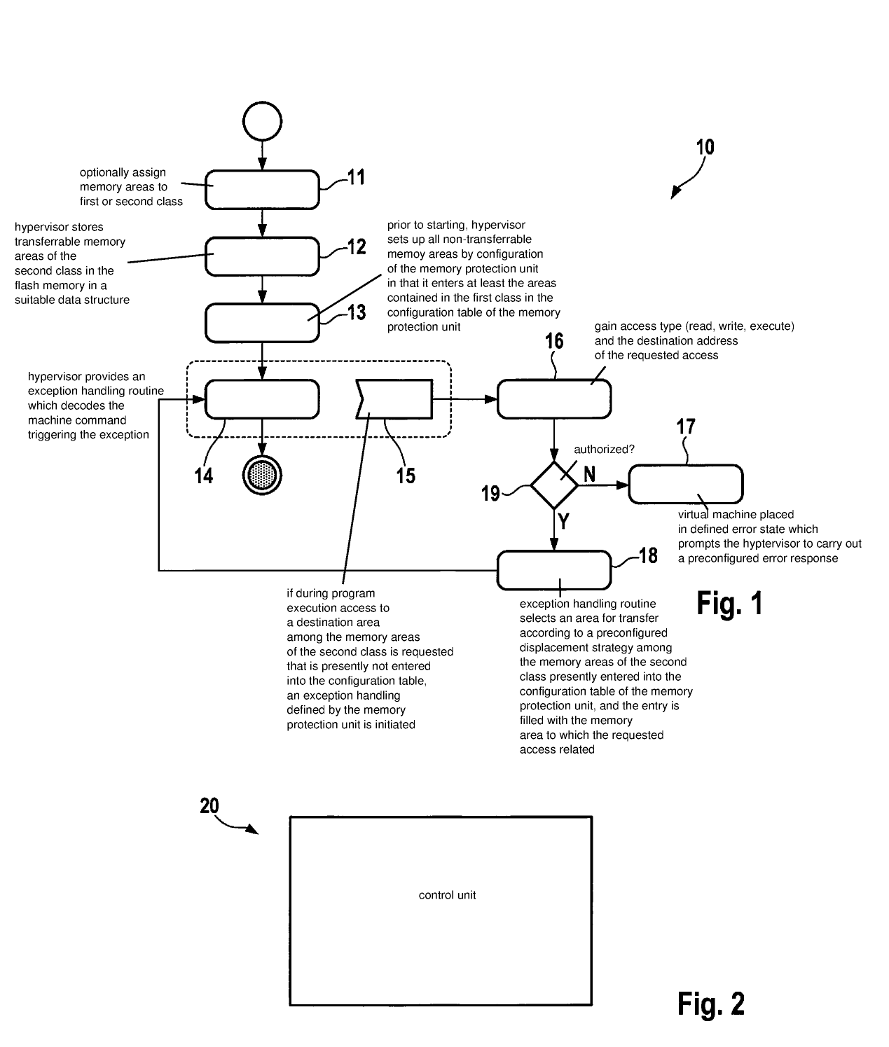

FIG. 1 illustrates the fundamental sequence of one exemplary embodiment of a method 10 according to the present invention. For the purpose of the following description, it shall be assumed that the considered system includes a larger number of memory areas to be distinguished than the memory protection unit supports in terms of hardware.

The approach discussed hereafter is based on a basic aspect that the hypervisor replaces configuration entries of the memory protection unit regarding the run time as needed. This approach provides the virtual machine operated as a guest system of the hypervisor with an execution context which takes all memory areas specified in the configuration of the particular machine into consideration even when the number of configured memory areas exceeds that of the memory protection unit.

The described replacement follows a configurable displacement strategy derived from the operating system theory as it is used according to the related art for cache memories, for example. For example, it is possible to transfer the configuration entry whose last use by the MPU dates back the furthest (least recently used, LRU).

The implementation follows the following pattern in accordance with the illustration: In the development phase, the memory areas to be configured are initially optionally assigned to a first or a second class (activity 11). The configuration language of the hypervisor allows the integrator for this purpose to identify individual areas either as non-transferable (first class) or transferable (second class). It shall be understood that, in this case, at least one configuration entry of the memory protection unit should always be reserved to the memory areas of the second class, if at least one area was assigned to this class.

During the classification of the memory areas, it should be noted that the waiting period for the execution of machine commands in transferred memory areas and for read and write accesses to such memory areas may be considerable. It is up to the integrator to decide which memory areas are to be configured as non-transferrable and which are to be configured as transferrable. As a function of the real time requirements of the respective application, the same applies to the selection of an advantageous displacement strategy.

The hypervisor then stores the transferrable memory areas of the second class in the flash memory in a suitable data structure (activity 12). For each area of this type, the structure includes its details relevant for an authorization check, i.e., in particular the boundaries of the address space taken up by it and the allowed access type of the particular guest system or process. Without departing from the scope of the present invention, in one alternative specific embodiment a checking routine which, for example, carries out a case distinction (switch statement) between the areas of the first and second classes may nonetheless be generated based on the classification made by way of the code generation.

Prior to starting, the hypervisor sets up all non-transferrable memory areas by configuration of the memory protection unit in that it enters at least the areas contained in the first class in the configuration table of the memory protection unit in this regard (activity 13). As long as the overall number of the memory areas distinguished by the configuration does not exceed the number of available table entries, no transfer of individual entries is necessary. However, if the number of provided memory areas exceeds the capability of the memory protection unit, such a transfer is possible during the run time of the virtual machine.

A “configuration table” of the memory protection unit includes, in particular, the page table typically provided in modern memory management units, which is primarily used to translate virtual memory addresses into physical memory addresses. Such a page table may have a one-stage, a multi-stage or—to save memory space—also an inverted design, the searching in the page table being expeditable by an upstream so-called hash table. The aforementioned entry (activity 13) in the page table in this case takes place by the generation of a page table entry (PTE).

In a simpler specific embodiment, the configuration table may nonetheless be embodied by registers of a simple memory protection unit having no virtual memory management, as they are provided, for example, within the scope of the AUTOSAR development partnership for isolating different software components (SW-Cs) of a generic control unit (electronic control unit, ECU). The entries of the configuration table known to the electronics expert as “regions”—typically, between 2 and 32 such regions per MPU, depending on model—in this case denote so-called partitions within the context of the AUTOSAR, which in turn may each include multiple software components as mutually delimited protection areas. For each of these regions, the register contents of the MPU specify the access types permissible for the respective partition through manufacturer-dependent bit sequences, at sometimes a further distinction being made between accesses by “privileged” and “non-privileged” software.

When the virtual machine during the program execution requests access to a memory area which is encompassed by the second class and thus, in principle, is transferrable, but already preconfigured in the memory protection unit—this case is not shown in the illustration—no intervention by the hypervisor is necessary. However, if during the program execution access to a destination area among the memory areas of the second class is requested which is presently not entered into the configuration table (event 15), an exception handling defined by the memory protection unit is initiated. The hypervisor provides an exception handling routine (exception handler) registered for this purpose, which decodes the machine command triggering the exception (activity 14), and in this way gains the access type—read, write or execute—and the destination address of the requested access (activity 16). Based on this information and the data structure stored in activity 12, the exception handling routine subjects the provided access to an authorization check (decision 19) and, if it fails (branch N), places the virtual machine in a defined error state, which prompts the hypervisor to carry out a preconfigured error response (activity 17), such as the reboot of the virtual machine. In this case, the memory protection unit recognizes the attempt to access the protected address space without authorization, based on the authorizations stored in the configuration table as a so-called protection violation (segmentation violation, segmentation fault, segfault) or access violation, and signals this to the hypervisor. In a UNIX-like operating system, this signaling could take place, for example, by the exception condition SIGSEGV, in the case of microprocessors with IA-32 or X86 architecture or in the case of more powerful microcontrollers by an interrupt.

If, due to a successfully completed authorization check 19, the requested access is to be granted (branch Y), the exception handling routine (16, 17, 18, 19, Y, N) selects an area for the transfer according to the preconfigured displacement strategy among the memory areas of the second class presently entered into the configuration table of the memory protection unit. The entry occupied by this discarded area is now filled with the memory area to which the requested access relates (activity 18). This destination area—defined essentially by the boundaries of the address space taken up by it and the allowed access type—may again be derived from the data structure stored in activity 12. In this way, the exception handling (16, 17, 18, 19, Y, N) may ultimately be completed, the control flow in the virtual machine may be continued, and the machine command 14 requesting the access may now be again processed without a memory protection violation.

This method 10 may be implemented in software or hardware or in a mixed form made up of software and hardware, for example in a control unit 20, as the schematic representation of FIG. 2 illustrates.

1-10. (canceled)

11. A method for protecting a working memory with the aid of a memory protection unit, comprising:
assigning memory areas of the working memory are to a first class or a second class;
prior to a program execution, entering at least the memory areas assigned to the first class into a configuration table of the memory protection unit; and
when access to a destination area among the memory areas of the second class is requested during the program execution, entering the destination area into the configuration table before the access is granted.

12. The method as recited in claim 11, wherein the requested access is handled by an exception handling routine, the exception handling routine carrying out an authorization check at least based on the destination area, and the exception handling routine triggers a preconfigured error response if the authorization check fails.

13. The method as recited in claim 12, wherein the exception handling routine decodes an access type and a destination address within the destination area to which the access relates based on a machine command requesting the access, and the authorization check is furthermore carried out based on the access type and the destination address.

14. The method as recited in claim 13, wherein at least one memory area of the second class is entered into the configuration table, and if the access is granted, the exception handling routine replaces the memory area in the configuration table with the destination area, and prompts a renewed processing of the machine command.

15. The method as recited in claim 14, wherein multiple memory areas of the second class are entered into the configuration table, and if the access is granted, the exception handling routine selects a memory area among the entered memory areas of the second class according to a preconfigured displacement strategy, replaces the selected memory area in the configuration table with the destination area, and prompts a renewed processing of the machine command.

16. The method as recited in claim 12, wherein based on the memory areas of the second class, a checking routine is generated prior to the program execution, and the authorization check includes a call up of the checking routine.

17. The method as recited in claim 12, wherein the memory areas of the second class are stored in a data structure preferably in a flash memory, and the authorization check is furthermore carried out based on the data structure.

18. A non-transitory machine-readable storage medium on which is stored a computer program for protecting a working memory with the aid of a memory protection unit, the computer program, when executed by a computer, causing the computer to perform:
assigning memory areas of the working memory are to a first class or a second class;
prior to a program execution, entering at least the memory areas assigned to the first class into a configuration table of the memory protection unit; and
when access to a destination area among the memory areas of the second class is requested during the program execution, entering the destination area into the configuration table before the access is granted.

19. A device configured for protecting a working memory with the aid of a memory protection unit, the device configured to:
assign memory areas of the working memory are to a first class or a second class;
prior to a program execution, enter at least the memory areas assigned to the first class into a configuration table of the memory protection unit; and
when access to a destination area among the memory areas of the second class is requested during the program execution, enter the destination area into the configuration table before the access is granted.
